(19) United States
(12) Patent Application Publication
(10) Pub. No.: US 2016/0040460 A1
(43) Pub. Date: Feb. 11, 2016

(54) LOCKING/UNLOCKING DETECTION DEVICE

(71) Applicant: NEC Corporation, Tokyo (JP)

(72) Inventors: Shigeru KASAI, Tokyo (JP); Soichiro TAKATA, Tokyo (JP)

(73) Assignee: NEC Corporation, Tokyo (JP)

(21) Appl. No.: 14/781,754

(22) PCT Filed: Apr. 4, 2014
(86) PCT No.: PCT/JP2014/060001

§ 371 Date: Oct. 1, 2015

(30) Foreign Application Priority Data
Apr. 4, 2013 (JP) 2013-078460

(51) Int. Cl. E05C 19/16; E05B 47/00; E05C 19/02

(52) U.S. Cl. CPC E05C 19/16; E05C 19/02; E05B 47/0001; E05B 2047/0072

(57) ABSTRACT

A locking/unlocking detection device (10A) includes: a permanent magnet (12) that is attached to an opening/closing part (100) locked and unlocked by a locking mechanism (110); a vibration detection unit (11) that is attached to a base part (101) openably and closably supporting the opening/closing part (100); a magnetism detection unit (13) that is attached to the base part (101); a casing (15) that covers the vibration detection unit (11) and the magnetism detection unit (13); and a locking/unlocking detection unit (14). The vibration detection unit (11) detects vibration of the base part (101). The magnetism detection unit (13) detects magnetism of the permanent magnet (12). The locking/unlocking detection unit (14) detects locking/unlocking of the opening/closing part (100) from the vibration detected by the vibration detection unit (11) and the magnetism detected by the magnetism detection unit (13).

### TECHNICAL FIELD

The present invention relates to a locking/unlocking detection device that detects locking and unlocking of an opening/closing part.

### BACKGROUND ART

Devices that detect locking and unlocking of an opening/closing part of a door or a window have been proposed (for example, PTL 1). The device described in PTL 1 includes: a state detection switch (mechanical or magnetic) that enters an ON state or an OFF state as the deadbolt of the door lock comes out or in; a first antenna that transmits a signal when the state detection switch is in an ON state; and a second antenna that receives the signal from the first antenna. The first antenna is provided at a portion of the door frame. The second antenna is provided, for example, on a ceiling or a wall. In a locked state where the deadbolt of the door lock is positioned in an inner space, the state detection switch enters an ON state, the first antenna transmits a signal to the second antenna, and consequently the locked state is detected. In contrast, in an unlocked state where the deadbolt of the door lock is withdrawn from the inner space, the state detection switch enters an OFF state, the first antenna does not transmit any signal, and consequently the unlocked state is detected.

### CITATION LIST

### Patent Literature

PTL 1: Japanese Laid-open Patent Publication No. H4-11117

### SUMMARY OF INVENTION

### Technical Problem

The device described in PTL 1 requires complex operation for installing the components of the device (such as the state detection switch, the first antenna, and the second antenna) and hence requires high costs for the installation operation. For example, the operation mechanisms of locks equipped with deadbolts are not the same and vary widely. In view of this, it is necessary to adjust the positional relationship between the state detection switch and a deadbolt for each type of locks in order for the state detection switch to be able to appropriately switch the state between an ON state and an OFF state as the deadbolt comes out or in. In addition, the positional relationship between a strike box and a deadbolt varies according to conditions of operation for installing the opening/closing part. Accordingly, it is necessary to adjust the positional relationship between the state detection switch and a deadbolt for each lock. Furthermore, installation of the first antenna and the second antenna requires large-scale operation and hence requires high operation costs.

The present invention has been made in view of the above-described circumstances and has an object to provide an easily installable locking/unlocking detection device.

### Solution to Problem

To achieve the above-described object, a locking/unlocking detection device according to a first aspect of the present invention includes: a first magnet that is attached to an opening/closing part locked and unlocked by a locking mechanism; a vibration detection unit that is attached to a base part openably and closably supporting the opening/closing part and detects vibration of the base part; a magnetism detection unit that is attached to the base part and detects magnetism of the first magnet; a first casing that is attached to the base part and covers the vibration detection unit and the magnetism detection unit; and a locking/unlocking detection unit that detects locking/unlocking of the opening/closing part from the vibration detected by the vibration detection unit and the magnetism detected by the magnetism detection unit.

The locking/unlocking detection device according to a second aspect of the present invention includes: a first magnet that is attached to an opening/closing part locked and unlocked by a locking mechanism; a magnetism detection unit that is attached to a base part openably and closably supporting the opening/closing part and detects magnetism of the first magnet; a first casing that is attached to the base part, includes a counterbored part, and covers the magnetism detection unit; a vibration detection unit that is attached to the counterbored part and detects vibration of the base part; and a locking/unlocking detection unit that detects locking/unlocking of the opening/closing part from the vibration detected by the vibration detection unit and the magnetism detected by the magnetism detection unit.

### Advantageous Effects of Invention

According to the present invention, a locking/unlocking detection device can easily be installed.

### BRIEF DESCRIPTION OF DRAWINGS

FIG. 1 is a schematic diagram illustrating a locking/unlocking detection device according to Exemplary Embodiment 1.

FIG. 2 is a schematic diagram illustrating a locking/unlocking detection device according to Exemplary Embodiment 2.

FIG. 3 is a cross-sectional view schematically illustrating an internal structure of a casing of the locking/unlocking detection device according to Exemplary Embodiment 2.

FIG. 4 is a cross-sectional view schematically illustrating an internal structure of a casing of a locking/unlocking detection device according to Exemplary Embodiment 3.

FIG. 5 is a schematic diagram illustrating a locking/unlocking detection device according to Exemplary Embodiment 4.

FIG. 6 is a cross-sectional view schematically illustrating an internal structure of a casing of the locking/unlocking detection device according to Exemplary Embodiment 4.

FIG. 7 is a schematic diagram illustrating a locking/unlocking detection device according to a first modified example of Exemplary Embodiment 4.

FIG. 8 is a cross-sectional view schematically illustrating an internal structure of a casing of the locking/unlocking detection device according to the first modified example of Exemplary Embodiment 4.

FIG. 9 is a schematic diagram illustrating a locking/unlocking detection device according to a second modified example of Exemplary Embodiment 4.

FIG. 10 is a schematic diagram illustrating a locking/unlocking detection device according to Exemplary Embodiment 5.

FIG. 11 is a cross-sectional view schematically illustrating an internal structure of a casing of the locking/unlocking detection device according to Exemplary Embodiment 5.

FIG. 12 is a cross-sectional view schematically illustrating an internal structure of a casing of a locking/unlocking detection device according to Exemplary Embodiment 6.

FIG. 13 is a schematic diagram illustrating a locking/unlocking detection device according to Exemplary Embodiment 7.

FIG. 14 is a cross-sectional view schematically illustrating an internal structure of a casing of a locking/unlocking detection device according to Exemplary Embodiment 8.

FIG. 15 is a cross-sectional view schematically illustrating an internal structure of a casing of a locking/unlocking detection device according to Exemplary Embodiment 9.

FIG. 16 is a table presenting results of locking/unlocking detection.

### DESCRIPTION OF EMBODIMENTS

Exemplary embodiments according to the present invention are described with reference to the drawings. Note that, however, the present invention is not limited by the following exemplary embodiments and the drawings. Changes may be made to the following exemplary embodiments and the drawings. Moreover, in the following description, known technical matters that are not so important as it is necessary to describe here are omitted where appropriate in order to facilitate understanding of the present invention.

### Exemplary Embodiment 1

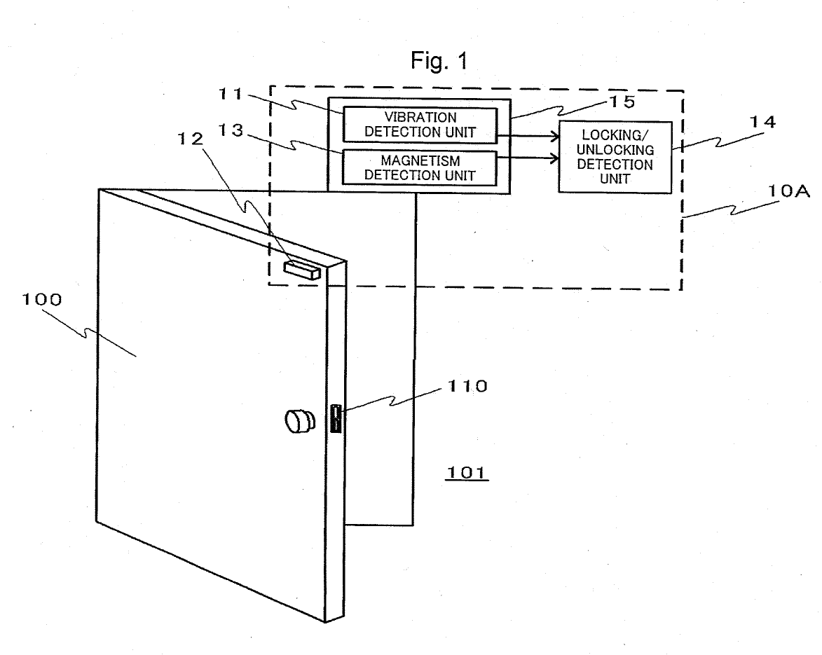

With reference to FIG. 1, Exemplary Embodiment 1 of the present invention is described. FIG. 1 illustrates a locking/unlocking detection device 10A according to this exemplary embodiment. The locking/unlocking detection device 10A detects locking and unlocking of an opening/closing part 100 locked or unlocked by a locking mechanism 110. The opening/closing part 100 is, for example, a door. The opening/closing part 100 is openably and closably supported by a base part 101. The base part 101 is, for example, a wall or a door frame provided to a wall.

The locking/unlocking detection device 10A includes a vibration detection unit 11, a permanent magnet 12, a magnetism detection unit 13, a locking/unlocking detection unit 14, and a casing 15. The vibration detection unit 11 detects vibration of the base part 101 by being in direct contact with the base part 101. Alternatively, the vibration detection unit 11 may detect vibration of the base part 101 by being in contact with the base part 101 via the casing 15. The permanent magnet 12 is attached to the opening/closing part 100. The magnetism detection unit 13 is attached to the base part 101. The magnetism detection unit 13 detects the magnetism of the permanent magnet 12. The locking/unlocking detection unit 14 detects locking and unlocking of the opening/closing part 100 by the locking mechanism 110, on the basis of the vibration of the base part 101 detected by the vibration detection unit 11 and the magnetism of the permanent magnet 12 detected by the magnetism detection unit 13. The casing 15 is attached to the base part 101. The casing 15 covers the vibration detection unit 11 and the magnetism detection unit 13. Alternatively, the casing 15 may cover the magnetism detection unit 13, and the vibration detection unit 11 may be attached to a counterbored part formed in the casing 15.

In the case of the locking/unlocking detection device 10A according to Exemplary Embodiment 1, the components only need to be installed in the opening/closing part 100, which is a door or a window, and the base part 101, which is a door frame or a wall. This allows the locking/unlocking detection device 10A to be installed without requiring any large-scale operation. Hence, the locking/unlocking detection device 10A can be installed easily and inexpensively. In addition, since the vibration detection unit 11 comes in direct contact with the base part 101 and is covered by the casing 15, the vibration detected by the vibration detection unit 11 does not include vibration attributable to the mechanical characteristics of the casing 15. In other words, the vibration detection unit 11 can detect vibration attributable only to the motion occurring at the opening/closing part 100 and the locking mechanism 110. Hence, the locking/unlocking detection device 10A can highly accurately detect locking and unlocking by the locking mechanism 110. Further, intrusion of dust into the vibration detection unit 11 can be reduced, which improves the durability of the locking/unlocking detection device 10A.

Even when the casing 15 covers the magnetism detection unit 13 and the vibration detection unit 11 is attached to the counterbored part formed in the casing 15, the locking/unlocking detection device 10A can be installed easily and inexpensively without requiring any large-scale operation.

### Exemplary Embodiment 2

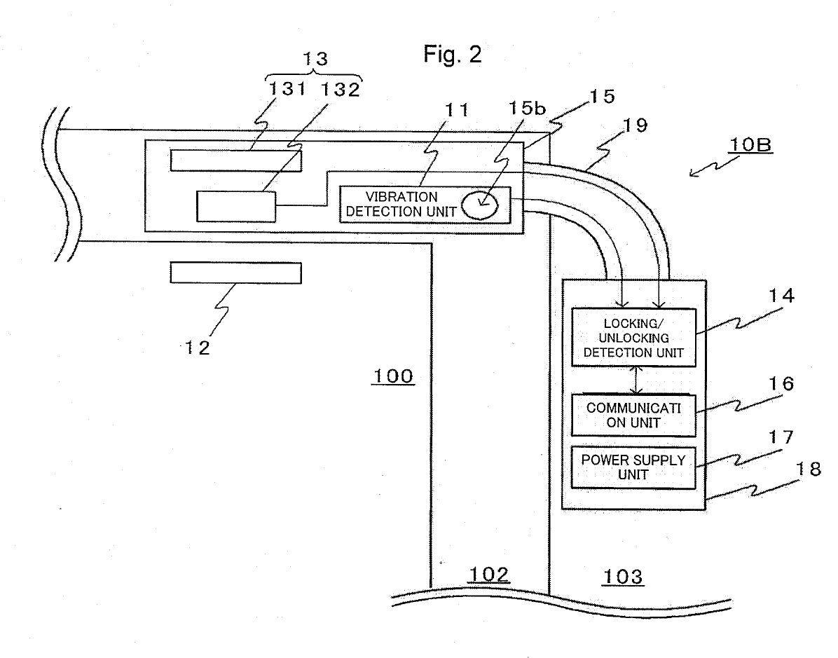

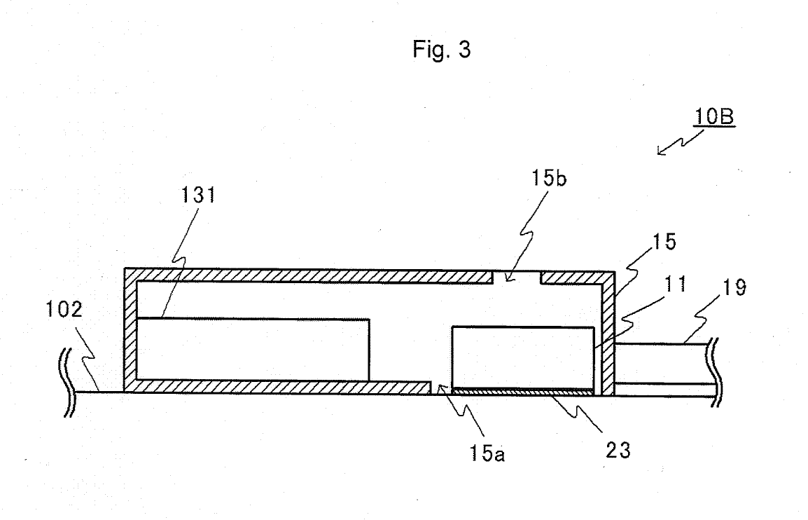

A locking/unlocking detection device 10B according to Exemplary Embodiment 2 of the present invention is described. In each of Exemplary Embodiment 2 and the subsequent exemplary embodiments, the same numerals are assigned to the same components as those in the other exemplary embodiments, and overlapping description is omitted as appropriate. FIG. 2 is a schematic diagram illustrating the locking/unlocking detection device 10B. FIG. 3 is a cross-sectional view schematically illustrating an inner structure of the casing 15. In this exemplary embodiment, the opening/closing part 100 is openably and closably supported by a frame body 102 provided to a wall part 103.

As illustrated in FIG. 2, the locking/unlocking detection device 10B includes a vibration detection unit 11, a permanent magnet 12, a magnetism detection unit 13, a locking/unlocking detection unit 14, a casing 15, a communication unit 16, a power supply unit 17, a processing-side casing 18, and a cable 19.

The vibration detection unit 11 includes a vibration sensor. The vibration sensor may employ a measuring system of capacitance type, eddy-current type, laser Doppler type, or a measuring system using a piezoelectric element. The vibration sensor outputs a signal including signal components representing measured vibration. The vibration detection unit 11 is attached directly to the frame body 102 with an adhesive tape 23, for example. The vibration detection unit 11 detects vibration of the frame body 102 and thereby detects vibration caused by locking and vibration caused by unlocking by the locking mechanism 110. For example, when the locking mechanism 110 provided to the opening/closing part 100 is locked or unlocked, members constituting the locking mechanism 110 (e.g., a strike hole formed in the strike box and a deadbolt) come in contact with or rub against each other. Due to such contact or friction between members, vibration occurs at the locking mechanism 110. The vibration detection unit 11 detects vibration of the frame body 102, consequently detects vibration transmitted from the locking mechanism 110 to the frame body 102, and outputs, to the locking/unlocking detection unit 14, a signal including signal components representing vibration caused by locking or vibration caused by unlocking by the locking mechanism 110.

The permanent magnet 12 is attached to the opening/closing part 100 so as to face the magnetism detection unit 13 in the state where the opening/closing unit 100 is closed. The permanent magnet 12 is away from the magnetism detection unit 13 in the state where the opening/closing part 100 is open, whereas the permanent magnet 12 faces the magnetism detection unit 13 in the state where the opening/closing part 100 is closed. The permanent magnet 12 is attached to the opening/closing part 100 with an adhesive double coated tape, adhesive, or screws, for example. Alternatively, the permanent magnet 12 may be covered with metal or resin except for the portion that is to face the magnetism detection unit 13.

In this exemplary embodiment, the magnetism detection unit 13 is housed in the casing 15. The casing 15 is attached to the frame body 102, and consequently the magnetism detection unit 13 is attached to the frame body 102. Alternatively, the magnetism detection unit 13 may be attached directly to the frame body 102.

The magnetism detection unit 13 includes a permanent magnet 131, which is to face the permanent magnet 12 in a state where the opening/closing part 100 is closed, and a reed switch 132. The reed switch 132 outputs a signal representing whether the permanent magnet 12 and the permanent magnet 131 are facing (or close to each other) or are away from each other. When the opening/closing part 100 is closed, which causes the permanent magnet 131 and the permanent magnet 12 to face each other, the reed switch 132 operates upon application of a high magnetic field and outputs, for example, a LOW signal to the locking/unlocking detection unit 14. In contrast, when the opening/closing part 100 is open, which separates the permanent magnet 131 and the permanent magnet 12 from each other, the reed switch 132 stops operating and outputs, for example, a HIGH signal to the locking/unlocking detection unit 14.

In this exemplary embodiment, the casing 15 houses the permanent magnet 131 and the reed switch 132 of the magnetism detection unit 13 as illustrated in FIG. 3. The casing 15 includes an opening part 15a. The casing 15 is attached to the frame body 102 so that the vibration detection unit 11 is disposed in the opening part 15a, and covers the vibration detection unit 11. The permanent magnet 131 and the reed switch 132 of the magnetism detection unit 13 may be attached directly to the frame body 102, disposed in the opening part 15a as the vibration detection unit 11, and covered by the casing 15.

It is preferable that there is a gap between the vibration detection unit 11 and the casing 15. This prevents the vibration detection unit 11 and the casing 15 from coming in contact with each other, which reduces the influence of the mechanical characteristics of the casing 15 on the vibration detected by the vibration detection unit 11. In addition, since the vibration detection unit 11 is covered by the casing 15, the vibration detection unit 11 is less likely to be affected by sound attributable to the environment. These enable the vibration detection unit 11 to accurately detect vibration caused by locking or unlocking of the locking mechanism 110. Further, since the magnetism detection unit 13 and the vibration detection unit 11 are covered by the casing 15, the magnetism detection unit 13 and the vibration detection unit 11 are prevented from being exposed to dust, which improves the durability of the locking/unlocking detection device 10B. The casing 15 is made of, for example, metal or resin. The casing 15 is attached to the frame body 102 with an adhesive double coated tape, adhesive, or screws, for example.

The casing 15 preferably includes a through hole 15b, which exposes the vibration detection unit 11. Since the pressing force of the vibration detection unit 11 can be adjusted using a special push-pull gauge via the through hole 15b, a decrease of the measurement accuracy attributable to fluctuations in pressure can be reduced. A cover for openably and closably covering the through hole 15b may be provided to the casing 15. The through hole 15b is preferably smaller than the vibration detection unit 11 so as to expose part of the vibration detection unit 11.

The locking/unlocking detection unit 14 includes a central processing unit (CPU), a read only memory (ROM), a random access memory (RAM), an external storage and the like. The locking/unlocking detection unit 14 judges whether the opening/closing part 100 is in a locked state or an unlocked state, according to signals output by the vibration detection unit 11 and the magnetism detection unit 13, and thereby detects locking/unlocking of the opening/closing part 100. For example, the locking/unlocking detection unit 14 judges whether the opening/closing part 100 is open or closed, according to a signal output by the magnetism detection unit 13. When judging that the opening/closing part 100 is open (receiving a LOW signal from the reed switch 132), the locking/unlocking detection unit 14 judges that the opening/closing part 100 is in an unlocked state irrespective of a signal output by the vibration detection unit 11, and consequently detects unlocking. In contrast, when judging that the opening/closing part 100 is closed according to a signal output by the magnetism detection unit 13 (receiving a HIGH signal from the reed switch 132), the locking/unlocking detection unit 14 judges whether the opening/closing part 100 is in a locked state or an unlocked state according to a signal output by the vibration detection unit 11, and detects locking/unlocking of the opening/closing part 100.

In order to detect locking/unlocking, the locking/unlocking detection unit 14 extracts a signal having a pre-stored characteristic frequency band (referred to as judgment target signal, below) from a signal output by the vibration detection unit 11 by way of frequency resolution. A characteristic frequency band is, for example, a frequency band including the eigenfrequencies of a structure system consisting of the structures existing in the course of transmission of vibration of the locking mechanism 110 to the vibration detection unit 11 (the system including the locking mechanism 110, the opening/closing part 100, and the frame body 102). When a signal output by the vibration detection unit 11 is an analog signal, the locking/unlocking detection unit 14 may convert the analog signal into a digital signal by using a sampling frequency.

When the vibration acceleration of the judgment target signal is larger than a pre-stored threshold value T1 for the acceleration of vibration caused by locking, the locking/unlocking detection unit 14 judges that the opening/closing part 100 is in a locked state. In contrast, when the vibration acceleration of the determination target signal is larger than a pre-stored threshold value T2 for the acceleration of vibration caused by unlocking, the locking/unlocking detection unit 14 judges that the opening/closing part 100 is in an unlocked state. Upon detection of a locked state or an unlocked state of the opening/closing part 100, the locking/unlocking detection unit 14 outputs a signal representing the detection result to the communication unit 16. Note that the locking/unlocking detection unit 14 may judge whether the opening/closing part 100 is in a locked state or an unlocked state with reference to multiple conditions. For example, the locking/unlocking detection unit 14 may judge that the opening/closing part 100 is in a locked state (or an unlocked state) when the vibration acceleration of a judgment target signal is larger than the threshold value T1 or T2 and the vibration acceleration of a judgment target signal is larger than (smaller than) a different threshold value T3 or T4 within a predetermined time period.

The communication unit 16 includes a communication interface cooperating with the CPU, an antenna and the like. The communication unit 16 communicates with external devices via a network. The communication unit 16 transmits detection results obtained by the locking/unlocking detection unit 14, to the external devices. For example, the communication unit 16 transmits detection results to external devices such as a user terminal, a terminal of a security company, a controller for setting a security mode and the like.

The power supply unit 17 supplies power to the components of the locking/unlocking detection device 10B such as the locking/unlocking detection unit 14 and the communication unit 16. The power supply unit 17 is, for example, a battery. The power supply unit 17 may be connected to an external power supply and supplies power to the components.

The processing-side casing 18 houses the locking/unlocking detection unit 14, the communication unit 16, and the power supply unit 17. The processing/side casing 18 is made of, for example, metal or resin. The processing-side casing 18 is attached to the wall part 103 (or the frame body 102) with an adhesive double coated tape, adhesive, or screws, for example.

The cable 19 connects the vibration detection unit 11 with the locking/unlocking detection unit 14 and the magnetism detection unit 13 with the locking/unlocking detection unit 14. The cable 19 is fixed to the frame body 102 by using a cable fastener, for example. The cable 19 may be disposed along the frame body 102 without being fixed thereto.

As described above, the locking/unlocking detection device 10B according to this exemplary embodiment provides the same or similar effect as that of the locking/unlocking detection device 10A according to Exemplary Embodiment 1. The casing 15 and the vibration detection unit 11 do not come in contact with each other, which can reduce an influence of the mechanical characteristics of the casing 15 on vibration to be detected by the vibration detection unit 11. This improves the accuracy of detecting locking and unlocking by the locking/unlocking detection device 10B. When the casing 15 includes the through hole 15b, the pressing force of the vibration detection unit 11 can be adjusted by using the special push-pull gauge via the through hole 15b, so that a decrease in measurement accuracy attributable to variation in pressing force can be reduced.

Since the locking/unlocking detection device 10B includes the communication unit 16, the locking/unlocking detection device 10B can notify the user and the like of a result of detecting locking/unlocking. This makes it possible to check locking while being away from home and to take measures against unlocking by an intruder at an early point, which improves user convenience. In addition, a terminal of a security company or a controller for setting a security mode can be notified of a result of detecting locking/unlocking by the locking/unlocking detection device 10B. In this way, an effective security system can be established. The communication unit 16 may receive data from external devices. In this case, upon receipt, from an external device, of a request for transmitting a detection result, the communication unit 16 transmits the detection result to the external device. Thus, the communication unit 16 of the locking/unlocking detection device 10B transmits data representing the detection result only when receiving a transmission request, hence reducing the power consumption of the locking/unlocking detection device 10B. Moreover, the user can obtain a result of detection by the locking/unlocking detection device 10B, when desiring to check whether the opening/closing unit 100 is locked/unlocked, which further improves user convenience. Here, the communication unit 16 and external devices may communicate with each other via wireless communications or wired communication.

### Exemplary Embodiment 3

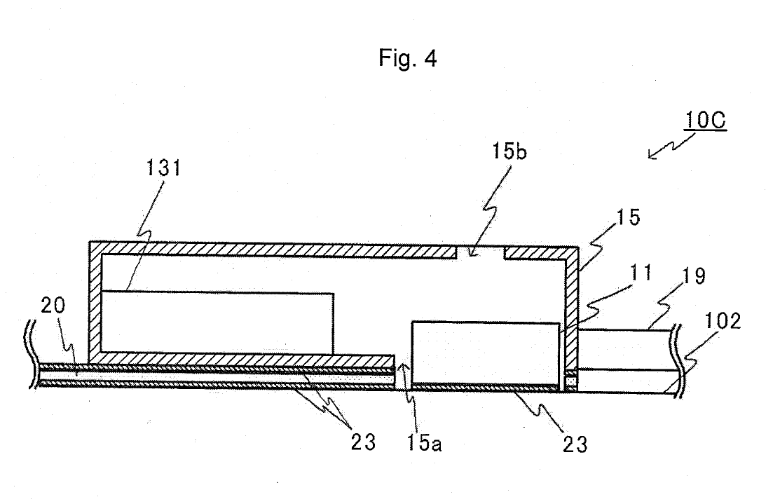

A locking/unlocking detection device 10C according to Exemplary Embodiment 3 of the present invention is described. The locking/unlocking detection device 10C is different from the locking/unlocking detection device 10B of Exemplary Embodiment 2 in that the locking/unlocking detection device 10C includes a vibration attenuator 20. Otherwise, the locking/unlocking detection device 10C has the same or similar configuration as that of the locking/unlocking detection device 10B. FIG. 4 is a cross-sectional view schematically illustrating an internal structure of a casing 15 of the locking/unlocking detection device 10C.

As illustrated in FIG. 4, in the locking/unlocking detection device 10C, the casing 15 is attached to a frame body 102 via the vibration attenuator 20. This makes it less likely that solid vibration attributable to the mechanical characteristics of the casing 15 is transmitted to the frame body 102, consequently improving the accuracy of detecting locking and unlocking by the locking/unlocking detection device 10C. The vibration attenuator 20 is made of, for example, a silicone resin material or a urethane resin material. The vibration attenuator 20 is fixed to the casing 15 and the frame body 102 with an adhesive double coated tape or adhesive, for example.

### Exemplary Embodiment 4

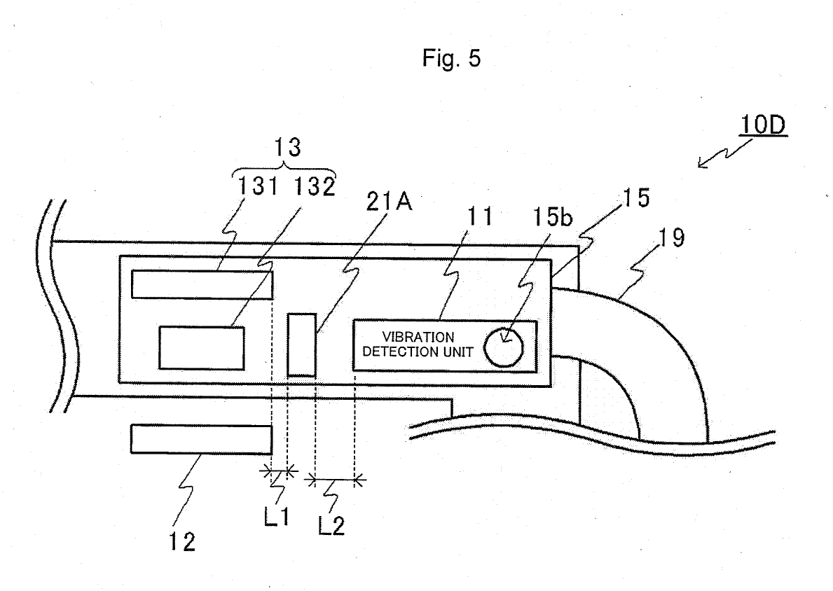

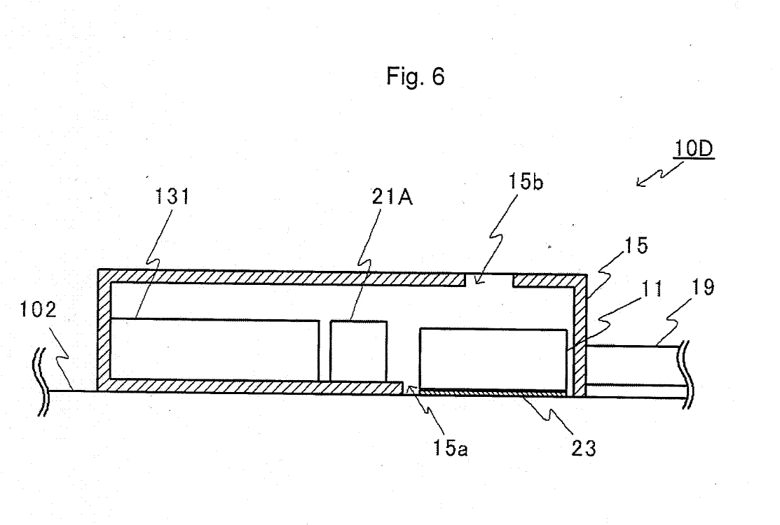

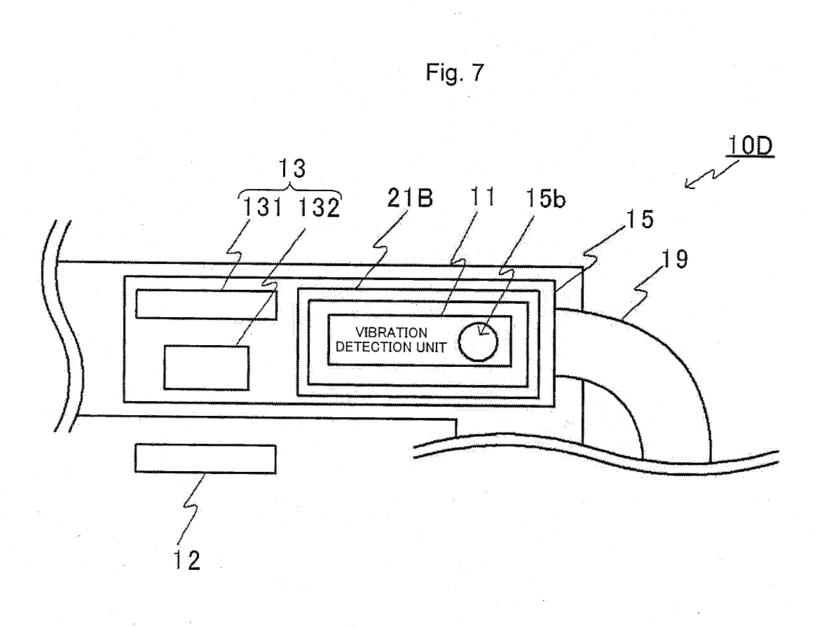

A locking/unlocking detection device 10D according to Exemplary Embodiment 4 of the present invention is described. The locking/unlocking detection device 10D is different from the locking/unlocking detection device 10B of Exemplary Embodiment 2 in that a magnetic body 21A is disposed between a permanent magnet 131 and a vibration detection unit 11 in the locking/unlocking detection device 10D. Otherwise, the locking/unlocking detection device 10D has the same or similar configuration as that of the locking/unlocking detection device 10B. FIG. 5 is a schematic diagram illustrating the locking/unlocking detection device 10D. FIG. 6 is a cross-sectional view schematically illustrating an inner structure of a casing 15 of the locking/unlocking detection device 10D. Note that a communication unit 16, a power supply unit 17, a processing-side casing 18, and the like are omitted in FIG. 5, FIG. 6, and FIGS. 7 to 15 to be described later.

As illustrated in FIGS. 5 and 6, in the locking/unlocking detection device 10D, the magnetic body 21A is disposed between the permanent magnet 131 of the magnetism detection unit 13 and the vibration detection unit 11. The magnetic body 21A has a rectangular parallelepiped shape. The magnetic body 21A separates the permanent magnet 131 and the vibration detection unit 11. The magnetic body 21A is preferably disposed so that the distance between the magnetic body 21A and the permanent magnet 131 (L1 in FIG. 5) is smaller than the distance between the magnetic body 21A and the vibration detection unit 11 (L2 in FIG. 5) (L1<L2). Disposing the magnetic body 21A between the permanent magnet 131 and the vibration detection unit 11 can reduce the influence of the magnetic field of each of the permanent magnets 12 and 131 on the vibration detection unit 11. This improves the measurement accuracy of the vibration detection unit 11. In addition, disposing the magnetic body 21A so as to make L1<L2 can efficiently reduce the influence of the magnetism of each of the permanent magnets 12 and 131 on the vibration detection unit 11. Although the magnetic body 21A is housed in the casing 15 in this exemplary embodiment (FIG. 6), the magnetic body 21A may be attached directly to the frame body 102.

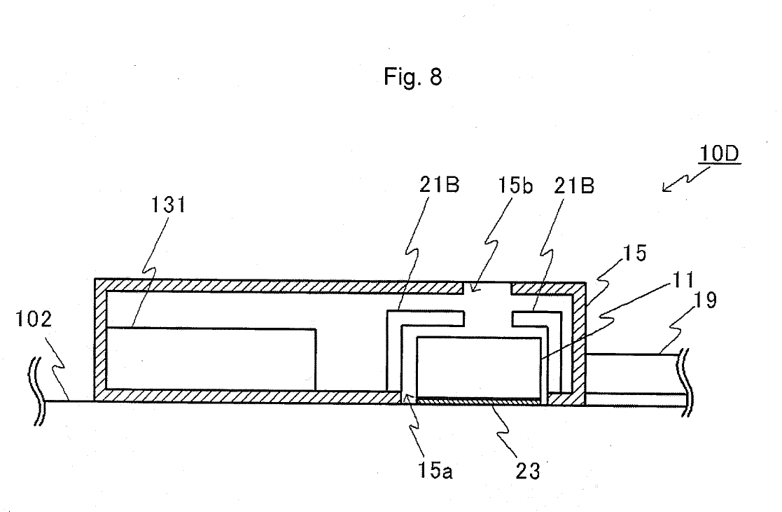

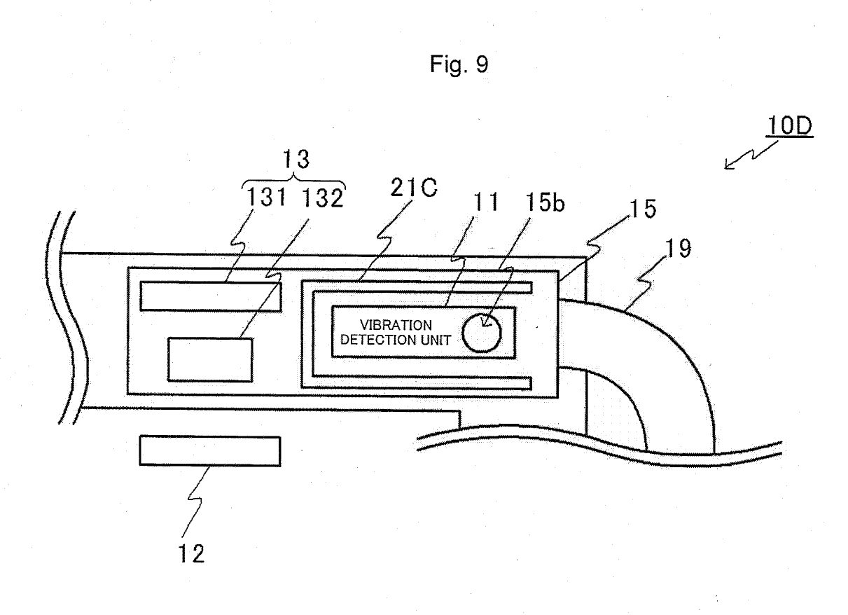

Here, the magnetic body 21A may be any magnetic body that shields magnetism by collecting the magnetic flux of each of the permanent magnets 12 and 131 while being disposed between the permanent magnet 131 and the vibration detection unit 11. As illustrated in FIGS. 7 and 8, a magnetic body 21B having a square shape (hollow rectangular parallelepiped shape) surrounding the vibration detection unit 11 may be disposed between the permanent magnet 131 and the vibration detection unit 11. This can prevent the magnetism of the permanent magnet 131 from detouring around the magnetic body 21B and consequently affecting the vibration detection unit 11, hence improving the measurement accuracy of the vibration detection unit 11. Alternatively, as illustrated in FIG. 9, a U-shaped magnetic body 21C may be disposed between the permanent magnet 131 and the vibration detection unit 11 so as to separate the permanent magnet 131 and the vibration detection unit 11. The measurement accuracy of the vibration detection unit 11 improves also in this case. The magnetic bodies 21A to 21C may cover an upper portion of the vibration detection unit 11 as illustrated in FIG. 8.

### Exemplary Embodiment 5

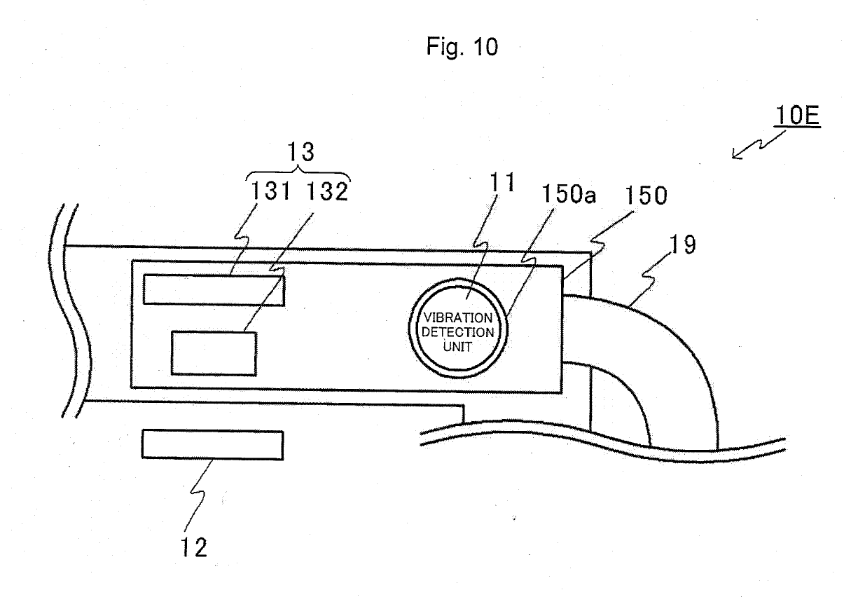

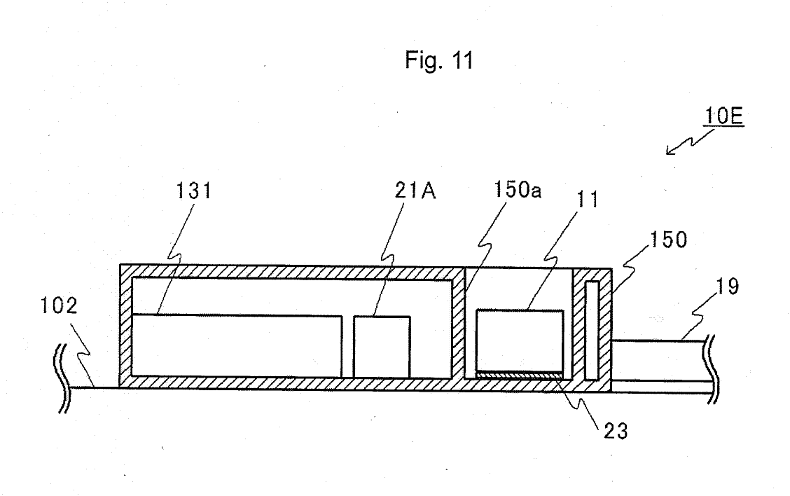

A locking/unlocking detection device 10E according to Exemplary Embodiment 5 of the present invention is described. The locking/unlocking detection device 10E is different from Exemplary Embodiment 2 in that a vibration detection unit 11 is attached to a frame body 102 via a casing 150. FIG. 10 is a schematic diagram illustrating the locking/unlocking detection device 10E. FIG. 11 is a cross-sectional view schematically illustrating an inner structure of the casing 150 of the locking/unlocking detection device 10E.

In the locking/unlocking detection device 10E, the casing 150 includes a counterbored part (closed-bottom recess) 150a, to which the vibration detection unit 11 is attached. The vibration detection unit 11 is disposed in the counterbored part 150a. The casing 150 is attached to the frame body 102, and thereby the vibration detection unit 11 is attached to the frame body 102 via the casing 150. This allows the locking/unlocking detection device 10E to be easily and inexpensively installed without requiring any large-scale operation in this embodiment as in Exemplary Embodiments 2 to 4. In addition, the pressing force of the vibration detection unit 11 can be adjusted by using a special push-pull gauge via the counterbored part 150a, so that a decrease in measurement accuracy attributable to variation in pressing force can be reduced.

### Exemplary Embodiment 6

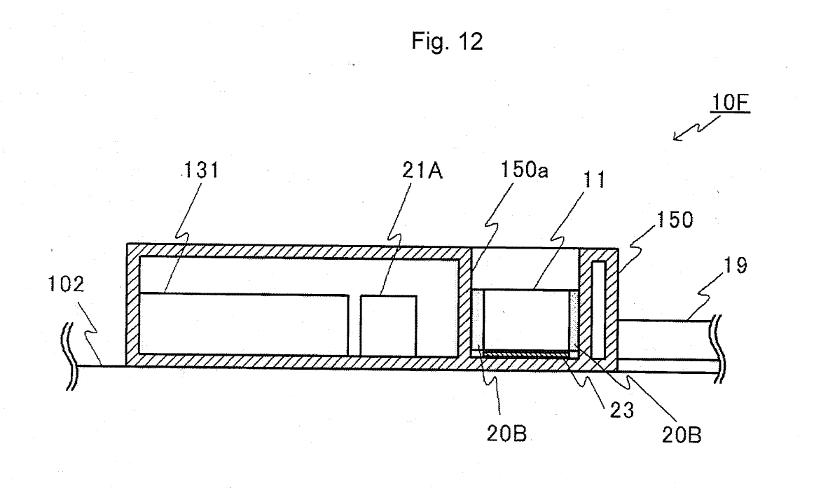

A locking/unlocking detection device 10F according to Exemplary Embodiment 6 of the present invention is described. The locking/unlocking detection device 10F is different from Exemplary Embodiment 5 in that the locking/unlocking detection device 10F includes a vibration attenuator 20B. FIG. 12 is a cross-sectional view schematically illustrating an inner structure of a casing 150 of the locking/unlocking detection device 10F.

In the locking/unlocking detection device 10F, the vibration attenuator 20B is disposed between a vibration detection unit 11 and the casing 150 while being not disposed on surfaces to which the vibration detection unit 11 and the casing 150 are attached. In other words, the vibration attenuator 20B is provided on side surfaces of the vibration detection unit 11. This makes it less likely for the vibration detection unit 11 to detect vibration other than that occurring in relation to the locking mechanism 110, hence improving the detection accuracy of the vibration detection unit 11. The vibration attenuator 20B is made of, for example, a silicone resin material or a urethane resin material. The vibration attenuator 20B is attached to the vibration detection unit 11 and the casing 150 while being positioned therebetween, with an adhesive double coated tape or adhesive.

### Exemplary Embodiment 7

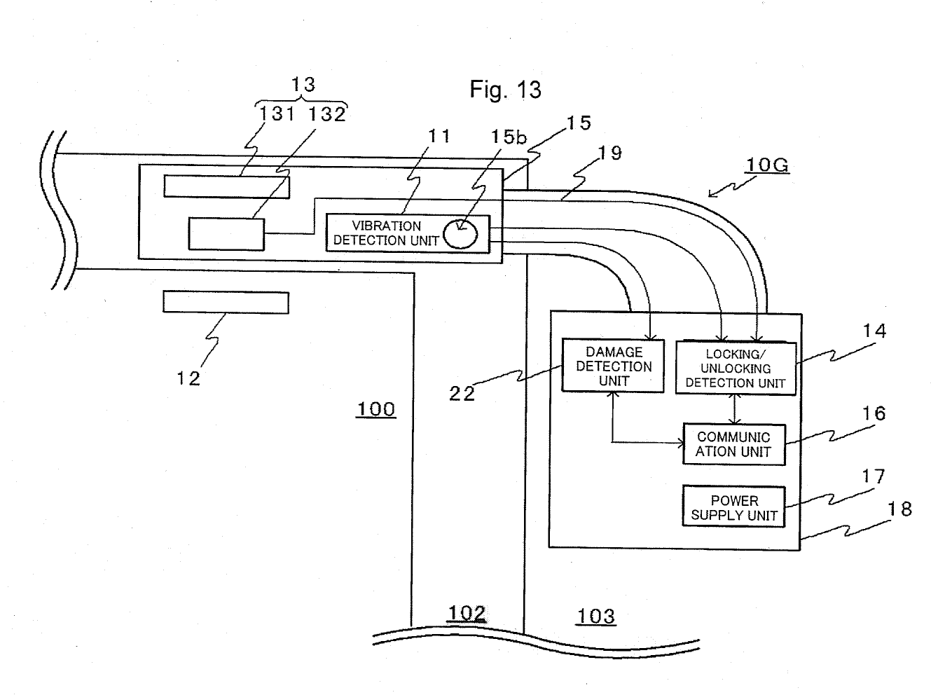

A locking/unlocking detection device 10G according to Exemplary Embodiment 7 of the present invention is described. As illustrated in FIG. 13, the locking/unlocking detection device 10G is different from Exemplary Embodiment 2 in that the locking/unlocking detection device 10G includes a damage detection unit 22. The damage detection unit 22 detects damage and damaging acts made to and around an opening/closing part 100 from the vibration detected by the vibration detection unit 11. For example, when the opening/closing part 100 includes a glass portion (when the opening/closing part 100 is a window pane or includes a fitting glass), the damage detection unit 22 detects that the glass portion is destroyed when happened. The damage detection unit 22 extracts a signal in a band corresponding to the eigenfrequencies of the glass portion, from a signal representing the vibration detected by the vibration detection unit 11, for example. When the extracted signal exceeds a pre-stored threshold value, the damage detection unit 22 judges that the glass portion is damaged and detects damaging of the glass portion.

As described above, the locking/unlocking detection device 10G is capable of detecting damaging of the opening/closing part 100 in addition to locking/unlocking of the opening/closing part 100. Alternatively, instead of the damage detection unit 22, the locking/unlocking detection device 10G may have a function of detecting, on the basis of vibration detected by the vibration detection unit 11, a different kind of acts causing the frame body 102 to vibrate. The locking/unlocking detection device 10G can not only detect locking and unlocking but also different kinds of acts causing vibrations such as damaging acts, only by appropriately setting judgment threshold values.

### Exemplary Embodiment 8

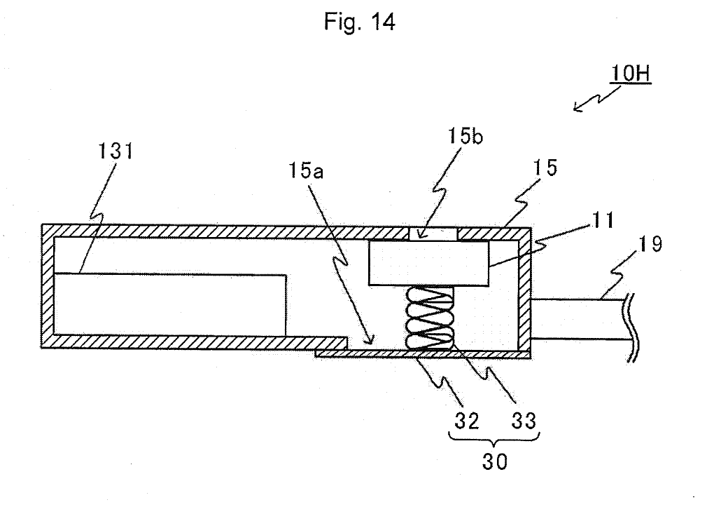

A locking/unlocking detection device 10H according to Exemplary Embodiment 8 of the present invention is described. The locking/unlocking detection device 10H is different from the locking/unlocking detection device 10B of Exemplary Embodiment 2 in that the locking/unlocking detection device 10H includes a non-permanently fixing member 30, which non-permanently fixes a vibration detection unit 11 to a casing 15. Otherwise, the locking/unlocking detection device 10H has the same or similar configuration as that of the locking/unlocking detection device 10B. FIG. 14 is a cross-sectional view schematically illustrating an inner structure of the casing 15 of the locking/unlocking detection device 10H.

In this exemplary embodiment, the non-permanently fixing member 30 includes a sheet member 32, which is attachable and detachable to the casing 15, and an elastic member 33. The sheet member 32 is a flat sheet to which, for example, an adhesive tape or adhesive is applied. The elastic member 33 is, for example, a coiled spring and is attached to the sheet member 32. In the locking/unlocking detection device 10H, the sheet member 32 is detachably attached to an outer wall surface of the casing 15 so as to cover part of the opening part 15a of the casing 15. The elastic member 33 presses the vibration detection unit 11 against an inner wall surface of the casing 15 in the state where the sheet member 32 is attached to the outer wall surface of the casing 15. In this way, the vibration detection unit 11 is non-permanently fixed to the casing 15 (FIG. 14).

In the locking/unlocking detection device 10H, the casing 15 and the vibration detection unit 11 can easily be separated from each other by detaching the sheet member 32 (non-permanently fixing member 30) from the casing 15. Hence, the locking/unlocking detection device 10H can easily be installed. In addition, since the vibration detection unit 11 is non-permanently fixed to the casing 15, the locking/unlocking detection device 10H is easy to handle in transportation and installation. Further, the locking/unlocking detection device 10H operates as the locking/unlocking detection device 10B of Exemplary Embodiment 2 and provides the same or similar effect as that of the locking/unlocking detection device 10B of Exemplary Embodiment 2.

### Exemplary Embodiment 9

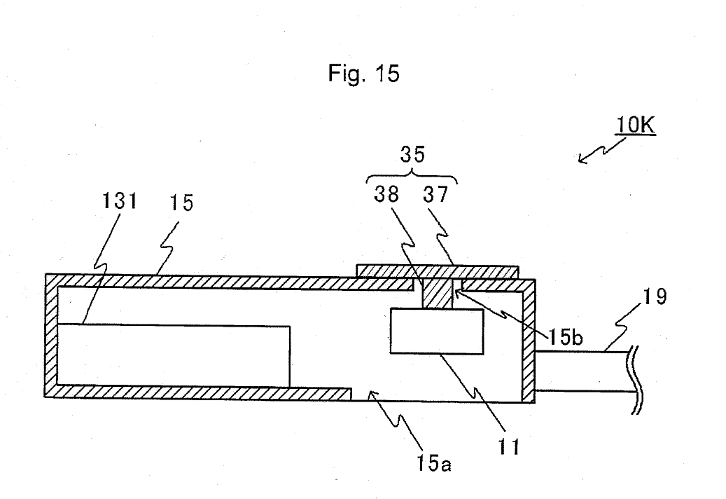

A locking/unlocking detection device 10K according to Exemplary Embodiment 9 of the present invention is described. The locking/unlocking detection device 10K is different from the locking/unlocking detection device 10B of Exemplary Embodiment 2 in that the locking/unlocking detection device 10K includes a non-permanently fixing member 35, which non-permanently fixes a vibration detection unit 11 to a casing 15. In addition, in this exemplary embodiment, the diameter of a through hole 15b of the casing 15 is smaller than the width of the vibration detection unit 11. Otherwise, the locking/unlocking detection device 10K has the same or similar configuration as that of the locking/unlocking detection device 10B. FIG. 15 is a cross-sectional view schematically illustrating an inner structure of the casing 15 of the locking/unlocking detection device 10K.

In this exemplary embodiment, the non-permanently fixing member 35 includes a mounting part 37 and an attaching part 38. The non-permanently fixing member 35 of this exemplary embodiment has, for example, a T-shape, where the mounting part 37 corresponds to the horizontal line of T and the attaching part corresponds to the vertical line of T. The mounting part 37 is disposed on an outer wall surface of the casing 15. The mounting part 37 is disposed so as to extend across the opening of the through hole 15b, on the outer wall surface of the casing 15. The attaching part 38 extends from a portion of the mounting part 37, the portion extending across the through hole 15b, to the inside of the casing 15 via the through hole 15b. Adhesive, for example, is applied to an end portion of the attaching part 38, and thereby the vibration detection unit 11 is detachably attached to the end portion of the attaching part 38. Since the mounting part 37 extends across the opening of the through hole 15b on the outer wall surface of the casing 15 and the diameter of the through hole 15b is smaller than the width of the vibration detection unit 11, the non-permanently fixing member 35 does not fall out via the through hole 15b. Hence, the vibration detection unit 11 is non-permanently fixed to the casing 15 by use of the non-permanently fixing member 35. The non-permanently fixing member 35 is made of urethane rubber, for example.

In the locking/unlocking detection device 10K, the vibration detection unit 11 is separated from the attaching part 38 by pulling the attaching part 38 (non-permanently fixing member 35) out from the through hole 15b, thus being able to easily separate the casing 15 and the vibration detection unit 11 from each other. Hence, the locking/unlocking detection device 10K can easily be installed. Moreover, since the vibration detection unit 11 is non-permanently fixed to the casing 15, the locking/unlocking detection device 10K is easy to handle in transportation and installation. Further, the locking/unlocking detection device 10K operates as the locking/unlocking detection device 10B of Exemplary Embodiment 2 and provides the same or similar effect as that of the locking/unlocking detection device 10B of Exemplary Embodiment 2. The mounting part 36 may be detachably attached to the outer wall surface of the casing 15 with adhesive or an adhesive double coated tape being applied to a surface of the mounting part 36, the surface being to come in contact with the casing 15. In this way, even when the diameter of the through hole 15b is larger than the width of the vibration detection unit 11, the vibration detection unit 11 can be non-permanently fixed to the casing 15.

### Example 1

Example 1 of the present invention is described. A locking/unlocking detection device 10B of this example has the same or similar configuration as that in Exemplary Embodiment 2. Specifically, an opening/closing part 100 is an entrance door. The dimensions of the door is 1800 mm in length×1000 mm in width. The frame body 102 is the frame of the entrance door and is attached to the wall part 103. The locking mechanism 110 is a lock with a hook deadbolt.

A permanent magnet 12 attached to the opening/closing part 100 is a ferrite permanent magnet. The dimensions of the permanent magnet 12 is 30 mm (length)×7 mm (width)×7 mm (height). The permanent magnet 12 is disposed on an upper portion of the opening/closing part 100 with an adhesive double coated tape so as to have a distance of 30 mm from a permanent magnet 131 to be described later in a state where the opening/closing part 100 is closed.

The vibration sensor of the vibration detection unit 11 is a piezoelectric acceleration sensor with a built-in signal amplifier circuit. The dimensions of the vibration sensor of the vibration detection unit 11 is 8 mm (length)×8 mm (width)×4 mm (height). The vibration sensor is disposed on an upper portion of the door frame with an adhesive double coated tape.

The permanent magnet 131 of the magnetism detection unit 13 is a ferrite permanent magnet. The dimensions of the permanent magnet 131 is 30 mm (length)×7 mm (width)×7 mm (height). A reed switch 132 of the magnetism detection unit 13 is a reed switch having dimensions of 40 mm (length)×φ3 mm. When the permanent magnet 131 and the permanent magnet 12 face each other (in a state where the opening/closing part 100 is closed), the contact of the reed switch 132 is opened, and the magnetism detection unit 13 outputs a HIGH signal to the locking/unlocking detection unit 14. When the permanent magnet 131 and the permanent magnet 12 are separated from each other (in a state where the opening/closing part 100 is open), the contact of the reed switch 132 comes into conduction, and the magnetism detection unit 13 outputs a LOW signal to the locking/unlocking detection unit 14. The permanent magnet 131 and the reed switch 132 are housed in a casing to be described later and disposed on an upper portion of the door frame.

A casing 15 is made of non-magnetic aluminum (100 mm (length)×50 mm (width)). The casing 15 is disposed on an upper portion of the door frame so as to cover the vibration sensor of the vibration detection unit 11 and so that the vibration sensor of the vibration detection unit 11 is disposed at the opening part 15a of the casing 15, in a state where the permanent magnet 131 and the reed switch 132 are housed in the casing 15. The casing 15 is disposed so as not to come in contact with the vibration sensor of the vibration detection unit 11. A through hole (through hole 15b) to be used for adjusting the vibration sensor of the vibration detection unit 11 is formed in the casing 15 (diameter of the through hole: φ5 mm). The casing 15 is fixed to the upper portion of the door frame with an adhesive double coated tape.

The locking/unlocking detection unit 14 is connected to the vibration sensor of the vibration detection unit 11 and the reed switch 132 of the magnetism detection unit 13. The locking/unlocking detection unit 14 includes a CPU, a RAM, digital bandpass filters, a red light emitting diode (LED), a green LED and the like.

The locking/unlocking detection unit 14 judges of locking/unlocking on the basis of a judgment target signal having characteristic frequencies of 100 Hz to 5 kHz (sampling frequency: 20 kHz), and detects locking/unlocking. In order to extract the judgment target signal from the signal output by the vibration sensor of the vibration detection unit 11, the locking/unlocking detection unit 14 includes digital bandpass filters having respective pass bands: the first band, 100 Hz to 500 Hz; the second band, 500 Hz to 1 kHz; and the third band 1 kHz to 5 kHz. The locking/unlocking detection unit 14 extracts the maximum acceleration in each of the bands from the vibration detected by the vibration detection unit 11. The locking/unlocking detection unit 14 judges whether the door is in a locked state or an unlocked state depending on whether or not the extracted maximum acceleration in each band is above a predetermined threshold value. The threshold values for the respective bands are set as follows: 0.1 m/s² for the first band; 0.2 m/s² for the second band; and 0.3 m/s² for the third band. When the maximum acceleration in the first band and the maximum acceleration in the second band are not larger than the respective threshold values for the corresponding bands and the maximum acceleration in the third band is above the threshold value for the third band, the locking/unlocking detection unit 14 judges that the door is in a unlocked state and detects the unlocked state. In contrast, when the maximum acceleration in the first band is not larger than the threshold value for the first band and the maximum acceleration in the second band and the maximum acceleration in the third band are above the respective threshold values for the corresponding bands, the locking/unlocking detection unit 14 judges that the door is in a locked state and detects the locked state.

Upon receipt of a HIGH signal output by the magnetism detection unit 13, the locking/unlocking detection unit 14 judges that the door is open and turns on the red LED. In contrast, upon receipt of a LOW signal output by the magnetism detection unit 13, the locking/unlocking detection unit 14 judges that the door is closed and turns on the green LED.

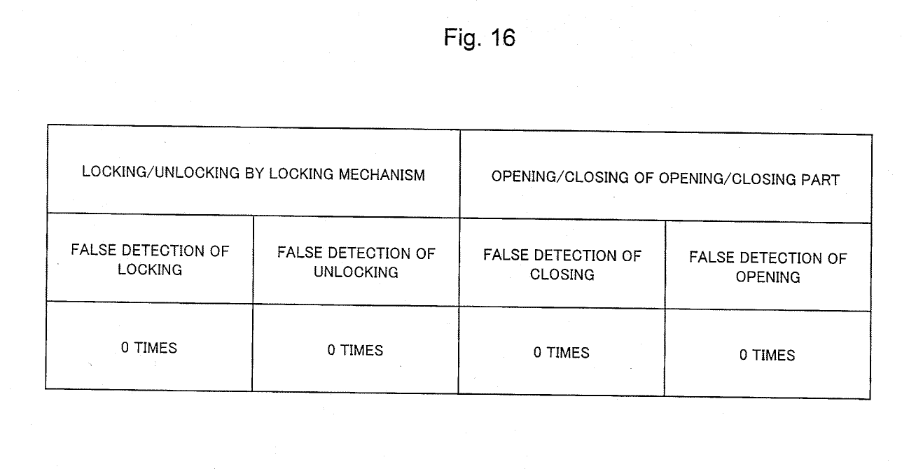

Whether the door (opening/closing part 100) is in an opened/closed state and is in a locked/unlocked state was detected by use of the locking/unlocking detection device 10B of this example by opening the door 30 times and closing the door 30 times as well as locking the door 30 times and unlocking the door 30 times under the above-described conditions. As presented in FIG. 16, the locking/unlocking detection device 10B of this example accurately detected the opened/closed states and the locked/unlocked states of the door.

### Example 2

A locking/unlocking detection device 10C of this example has the same or similar configuration as that in Exemplary Embodiment 3 and is different from that in Example 1 in that the locking/unlocking detection device 10C includes a vibration attenuator 20. In this example, the vibration attenuator 20 is made of a urethane rubber material (thickness of 1 mm). The vibration attenuator 20 is attached to the casing 15 and the frame body 102 with adhesive double coated tapes. Under the same or corresponding conditions as those of the Example 1 otherwise, an opened/closed state and a locked/unlocked state of the door was detected by use of the locking/unlocking detection device 10C of this example. As presented in FIG. 16, the locking/unlocking detection device 10C of this example accurately detected the opened/closed states and the locked/unlocked states of the door.

### Example 3

A locking/unlocking detection device 10D of this example has the same or similar configuration as the locking/unlocking detection device 10D of Exemplary Embodiment 4, which includes the magnetic body 21A, and is different from Example 1 in that the locking/unlocking detection device 10D of this example includes a magnetic body 21A. In this example, the magnetic body 21A is made of nickel-treated pure iron. The dimensions of the magnetic body 21A are 7 mm (length)×5 mm (width)×5 mm (height). The magnetic body 21A is disposed so that the distance between the magnetic body 21A and the permanent magnet 131 (L1) is 5 mm and the distance between the magnetic body 21A and the vibration detection unit 11 (L2) is 10 mm. Under the same or corresponding conditions as those of the Example 1 otherwise, whether the door is in an opened/closed state and is in a locked/unlocked state was detected by use of the locking/unlocking detection device 10D of this example. As presented in FIG. 16, the locking/unlocking detection device 10D of this example accurately detected the opened/closed states and the locked/unlocked states of the door.

### Example 4

In this example, a locking/unlocking detection device 10D includes a magnetic body 21B having a hollow rectangular parallelepiped shape. Otherwise, the locking/unlocking detection device 10D has the same or similar configuration as that of the locking/unlocking detection device 10D of Example 3 (the same or similar configuration as that of the locking/unlocking detection device 10D of Exemplary Embodiment 4, which includes the magnetic body 21B). In this example, the magnetic body 21B is made of nickel-treated pure iron. The external diameter of the magnetic body 21B is 40 mm (length)×40 (width)×20 mm (height), and the dimensions of the hollow part of the magnetic body 21B is 30 mm (length)×30 mm (width)×20 mm (height). The magnetic body 21B is disposed so that the distance between the magnetic body 21B and the permanent magnet 131 is 5 mm and the distance between the magnetic body 21B and the vibration detection unit 11 is 10 mm. Under the same or corresponding conditions as those of the Example 3 otherwise, whether the door is in an opened/closed state and is in a locked/unlocked state was detected by use of the locking/unlocking detection device 10D of this example. As presented in FIG. 16, the locking/unlocking detection device 10D of this example accurately detected the opened/closed states and the locked/unlocked states of the door.

### Example 5

In this example, a locking/unlocking detection device 10D includes a U-shaped magnetic body 21C. Otherwise, the locking/unlocking detection device 10D has the same or similar configuration as that of the locking/unlocking detection device 10D of Example 3 (the same or similar configuration as the locking/unlocking detection device 10D in Exemplary Embodiment 4, which includes the magnetic body 21C). In this example, the magnetic body 21C is made of nickel-treated pure iron. The external diameter of the magnetic body 21C is 40 mm (length)×40 mm (width)×20 mm (height), and the dimensions of the hollow part of the magnetic body 21C are 30 mm (length)×30 mm (width)×20 mm (height). The magnetic body 21C is disposed so that the distance between the magnetic body 21C and the permanent magnet 131 is 5 mm and the distance between the magnetic body 21C and the vibration detection unit 11 is 10 mm. Under the same or corresponding conditions as those of the Example 3 otherwise, whether the door is in an opened/closed state and is in a locked/unlocked state was detected by use of the locking/unlocking detection device 10D of this example. As presented in FIG. 16, the locking/unlocking detection device 10D of this example accurately detected the opened/closed states and the locked/unlocked states of the door.

### Example 6

A locking/unlocking detection device 10E of this example has the same or similar configuration as that of Exemplary Embodiment 5. The locking/unlocking detection device 10E of this example is different from Example 1 in that a casing 150 includes a counterbored part 150a and the vibration detection unit 11 is attached to the counterbored part 150a. In this example, the dimensions of the counterbored part 150a are φ20 mm and a depth of 15 mm. Under the same or corresponding conditions as those of the Example 1 otherwise, whether the door is in an opened/closed state and is in a locked/unlocked state was detected by use of the locking/unlocking detection device 10E of this example. As presented in FIG. 16, the locking/unlocking detection device 10E of this example accurately detected the opened/closed states and the locked/unlocked states of the door.

### Example 7

In this example, a locking/unlocking detection device 10F is different from Example 6 in that the locking/unlocking detection device 10F includes a vibration attenuator 20B. Otherwise, the locking/unlocking detection device 10F has the same or similar configuration as that of locking/unlocking detection device 10E of Example 6. In this example, the vibration attenuator 20B is made of urethane rubber (thickness of 6.5 mm). The vibration attenuator 20B is disposed between a casing 150 and a side surface of a vibration detection unit 11. Under the same or corresponding conditions as those of the Example 6 otherwise, whether the door is in an opened/closed state and is in a locked/unlocked state was detected by use of the locking/unlocking detection device 10F of this example. As presented in FIG. 16, the locking/unlocking detection device 10F of this example accurately detected the opened/closed states and the locked/unlocked states of the door.

The exemplary embodiments and the examples of the present invention are described above. However, the present invention is not limited to the exemplary embodiments and the examples described above, and various modifications and applications are possible.

Detection of locking/unlocking may be based on any as long as being able to detect locking/unlocking by the locking mechanism 110 from vibration detected by the vibration detection unit 11 and magnetism detected by the magnetism detection unit 13. For example, the locking/unlocking detection unit 14 may detect locking/unlocking by using, as threshold values, physical values other than those representing vibration acceleration. Physical values used as threshold values may be those that are characteristic for locking and unlocking, for example, values each representing displacement or the velocity of vibration. The number of characteristic frequency bands of each of a signal to be used for detecting locking (judgment target signal) and a judgment target signal to be used for detecting unlocking may be two or more.

The locking/unlocking detection unit 14 may detect locking/unlocking by way of pattern matching between the waveform of the vibration detected by the vibration detection unit 11 in a predetermined frequency band and the waveform characteristic of each of locking and unlocking. Moreover, physical values used as threshold values may be those obtained directly from a signal detected by the vibration detection unit 11 or may be those obtained from a signal obtained by processing a signal detected by the vibration detection unit 11.

The position to which the vibration detection unit 11, the magnetism detection unit 13, and the casing 15 are attached is not limited to the frame body 102. For example, the vibration detection unit 11, the magnetism detection unit 13, and the casing 15 may be attached to the wall part 103. In addition, the position to which the vibration detection unit 11, the magnetism detection unit 13, and the casing 15 are attached is not limited to the upper portion of the frame body 102 as illustrated in FIG. 2 and other drawings. For example, the vibration detection unit 11, the magnetism detection unit 13, and the casing 15 may be attached to the vertical portion of the frame body 102. Moreover, the locking/unlocking detection unit 14, the communication unit 16, and the power supply unit 17 do not need to be housed in the processing-side casing 18. For example, at least one of the locking/unlocking detection unit 14, the communication unit 16, and the power supply unit 17 may be housed in the casing 15. Alternatively, the locking/unlocking detection devices 10A to 10H and 10K do not need to include the processing-side casing 18.

The user terminal with which the communication unit 16 communicates may be, for example, a mobile terminal such as a personal handy-phone system (PHS), a personal digital assistance or personal data assistance (PDA), a mobile phone, or a smartphone, a laptop personal computer (PC), a digital camera, or a game console.

The connection between the vibration detection unit 11 and the locking/unlocking detection unit 14 as well as the connection between the magnetism detection unit 13 and the locking/unlocking detection unit 14 are not limited to wired connections (connections using the cable 19). For example, the connection between the vibration detection unit 11 and the locking/unlocking detection unit 14 as well as the connection between the magnetism detection unit 13 and the locking/unlocking detection unit 14 may be wireless connections.

The vibration detection unit 11 may be any as long as being capable of detecting vibration caused by locking by the locking mechanism 110 and vibration caused by unlocking by the locking mechanism 110. The vibration detection unit 11 may include an analog filter or a digital filter.

Any ones of the exemplary embodiments, the examples, the modified examples, and the like described above may be combined. It is preferable that a combination be selected as appropriate for the use and the like.

Part of or all of the above-described exemplary embodiments may be described as in the following supplementary notes, although the present invention is not limited thereto.

### (Supplementary Note 1)

A locking/unlocking detection device including:

a first magnet that is attached to an opening/closing part locked and unlocked by a locking mechanism;

a vibration detection unit that is attached to a base part openably and closably supporting the opening/closing part and detects vibration of the base part;

a magnetism detection unit that is attached to the base part and detects magnetism of the first magnet;

a first casing that is attached to the base part and covers the vibration detection unit and the magnetism detection unit; and

a locking/unlocking detection unit that detects locking/unlocking of the opening/closing part from the vibration detected by the vibration detection unit and the magnetism detected by the magnetism detection unit.

### (Supplementary Note 2)

The locking/unlocking detection device according to Supplementary Note 1, wherein a gap is provided between the vibration detection unit and the first casing.

### (Supplementary Note 3)

The locking/unlocking detection device according to Supplementary Note 1 or 2, wherein the first casing includes a through hole that exposes the vibration detection unit.

### (Supplementary Note 4)

The locking/unlocking detection device according to any one of Supplementary Notes 1 to 3, including a non-permanently fixing member that non-permanently fixes the vibration detection unit to the first casing.

### (Supplementary Note 5)

The locking/unlocking detection device according to Supplementary Note 4, wherein

the non-permanently fixing member includes a sheet member that is detachably attached to the first casing and an elastic member that is attached to the sheet member and presses the vibration detection unit, and

the vibration detection unit is non-permanently fixed to the first casing by being pressed by the elastic member.

### (Supplementary Note 6)

The locking/unlocking detection device according to Supplementary Note 3, including a non-permanently fixing member that non-permanently fixes the vibration detection unit to the first casing, wherein

the non-permanently fixing member includes a mounting part that is disposed on an outer wall surface of the first casing and extends across an opening of the through hole at the outer wall surface of the first casing, and an attaching part that extends from the mounting part via the through hole and to which the vibration detection unit is detachably attached.

### (Supplementary Note 7)

A locking/unlocking detection device including:

a first magnet that is attached to an opening/closing part locked and unlocked by a locking mechanism;

a magnetism detection unit that is attached to a base part openably and closably supporting the opening/closing part and detects magnetism of the first magnet;

a first casing that includes a counterbored part and is attached to the base part so as to cover the magnetism detection unit;

a vibration detection unit that is attached to the counterbored part and detects vibration of the base part; and

a locking/unlocking detection unit that detects locking/unlocking of the opening/closing part from the vibration detected by the vibration detection unit and the magnetism detected by the magnetism detection unit.

### (Supplementary Note 8)

The locking/unlocking detection device according to Supplementary Note 7, including a vibration attenuation part that attenuates the vibration, and that is disposed between the vibration detection unit and the first casing while being not disposed on an attachment surface to which each of the vibration detection unit and the first casing is attached.

### (Supplementary Note 9)

The locking/unlocking detection device according to any one of Supplementary Notes 1 to 8, wherein the first casing is attached to the base part via a vibration attenuation part that attenuates the vibration.

### (Supplementary Note 10)

The locking/unlocking detection device according to any one of Supplementary Notes 1 to 9, wherein the magnetism detection unit includes a second magnet, and a magnetic body is disposed between the second magnet and the vibration detection unit.

### (Supplementary Note 11)

The locking/unlocking detection device according to Supplementary Note 10, wherein distance between the magnetic body and the second magnet is shorter than distance between the magnetic body and the vibration detection unit.

### (Supplementary Note 12)

The locking/unlocking detection device according to any one of Supplementary Notes 1 to 11, including a damage detection unit that detects damaging of the opening/closing part from the vibration detected by the vibration detection unit.

### (Supplementary Note 13)

The locking/unlocking detection device according to any one of Supplementary Notes 1 to 12, including:

a transmission unit that transmits a detection result obtained by the locking/unlocking detection unit to an external device; and

a second casing that houses the locking/unlocking detection unit and the transmission unit.

### (Supplementary Note 14)

The locking/unlocking detection device according to any one of Supplementary Notes 1 to 13, wherein the locking/unlocking detection unit detects unlocking of the opening/closing part when it is judged, from the magnetism detected by the magnetism detection unit, that the opening/closing part is open, while detecting locking/unlocking of the opening/closing part from the vibration detected by the vibration detection unit when it is judged, from the magnetism detected by the magnetism detection unit, that the opening/closing part is closed, and detects unlocking/locking of the opening/closing part accordingly.

Various exemplary embodiments and modifications can be made for the present invention without departing from the broad spirit and the scope of the present invention. The exemplary embodiments and the examples described above are for illustrating the present invention and are not intended to limit the scope of the present invention. In other words, the scope of the present invention is defined by the scope of claims and not by the exemplary embodiments and the examples. It is considered that the scope of the claims and various modifications made within the significance of the present invention equivalent to the scope of claims are within the scope of the invention.

The present invention is based on Japanese Patent Application No. 2013-78460, filed on Apr. 4, 2013. The description, the scope of claims, and all the drawings are incorporated in this description by reference.

### REFERENCE SIGNS LIST

10A to 10H, 10K locking/unlocking detection device
11 vibration detection unit
12 permanent magnet
13 magnetism detection unit
141 locking/unlocking detection unit
15 casing
15a opening part
15b through hole
16 communication unit
17 power supply unit
18 processing-side casing
19 cable
20, 20B vibration attenuator
21A to 21C magnetic body
22 damage detection unit
23 adhesive tape
30 non-permanently fixing member
32 sheet member
33 elastic member
35 non-permanently fixing member
37 mounting part
38 attaching part
100 opening/closing part (door)
101 base part
102 frame body (door frame)
103 wall part
150 casing
150a counterbored part

1. A locking/unlocking detection device comprising:
a first magnet that is attached to an opening/closing part locked and unlocked by a locking mechanism;
a vibration detection unit that is attached to a base part openably and closably supporting the opening/closing part and detects vibration of the base part;
a magnetism detection unit that is attached to the base part and detects magnetism of the first magnet;
a first casing that is attached to the base part and covers the vibration detection unit and the magnetism detection unit; and
a locking/unlocking detection unit that detects locking/unlocking of the opening/closing part from the vibration detected by the vibration detection unit and the magnetism detected by the magnetism detection unit.

2. The locking/unlocking detection device according to claim 1, wherein a gap is provided between the vibration detection unit and the first casing.

3. The locking/unlocking detection device according to claim 1, wherein the first casing includes a through hole that exposes the vibration detection unit.

4. A locking/unlocking detection device comprising:
a first magnet that is attached to an opening/closing part locked and unlocked by a locking mechanism;
a magnetism detection unit that is attached to a base part openably and closably supporting the opening/closing part and detects magnetism of the first magnet;
a first casing that includes a counterbored part and is attached to the base part so as to cover the magnetism detection unit;
a vibration detection unit that is attached to the counterbored part and detects vibration of the base part; and
a locking/unlocking detection unit that detects locking/unlocking of the opening/closing part from the vibration detected by the vibration detection unit and the magnetism detected by the magnetism detection unit.

5. The locking/unlocking detection device according to claim 4, comprising a vibration attenuation part that attenuates the vibration, and that is disposed between the vibration detection unit and the first casing while being not disposed on an attachment surface to which each of the vibration detection unit and the first casing is attached.

6. The locking/unlocking detection device according to claim 1, wherein the first casing is attached to the base part via a vibration attenuation part that attenuates the vibration.

7. The locking/unlocking detection device according to claim 1, wherein
the magnetism detection unit includes a second magnet, and
a magnetic body is disposed between the second magnet and the vibration detection unit.

8. The locking/unlocking detection device according to claim 7, wherein distance between the magnetic body and the second magnet is shorter than distance between the magnetic body and the vibration detection unit.

9. The locking/unlocking detection device according to claim 1, comprising a damage detection unit that detects damaging of the opening/closing part from the vibration detected by the vibration detection unit.

10. The locking/unlocking detection device according to claim 1, comprising:
a transmission unit that transmits a detection result obtained by the locking/unlocking detection unit to an external device; and
a second casing that houses the locking/unlocking detection unit and the transmission unit.
